(19) United States
(12) Patent Application Publication
(10) Pub. No.: US 2003/0175104 A1
(43) Pub. Date: Sep. 18, 2003

(54) Container handling system with rotary actuator

(75) Inventor: Claudiu D. Pruteanu, Kasson, MN (US)

Correspondence Address: NIKOLAI & MERSEREAU, P.A., 900 SECOND AVENUE SOUTH, SUITE 820, MINNEAPOLIS, MN, 55402, US

(73) Assignee: McNeilus Truck and Manufacturing, Inc., Dodge Center, MN

(21) Appl. No.: 10/366,846

(22) Filed: Feb. 14, 2003

Related U.S. Application Data
(60) Provisional application No. 60/357,565, filed on Feb. 15, 2002.

(51) Int. Cl. B65F 3/00

(52) U.S. Cl. 414/555

(57) ABSTRACT

A container grabbing device is disclosed which utilizes a rotary actuator to open and close opposed converging fingers of the grabber in which the actuator has reversing counter-rotating, in-line opposed output shafts, one of which is used to operate each finger.

### BACKGROUND OF THE INVENTION

I. Field of the Invention

The present invention relates generally to vehicle-mounted container handling devices for grabbing, lifting and tipping (unloading) refuse and/or recyclables from collection containers into charging compartments of collection vehicles. More particularly, this invention relates to a grabbing device that may be attached to a swivel-mounted articulated arm carried on a side loading collection vehicle which allows containers of various shapes and sizes to be efficiently handled during collection efforts. With even further particularity, the present invention involves a concept for using a hydraulic rotary actuator to operate the converging fingers of a grabber device for capturing and releasing a container to empty the container into a charging hopper of a refuse packer collection vehicle.

II. Related Art

It is known to provide gripper or grabbing mechanisms employing opposed converging and diverging fingers to grasp, lift and tip refuse containers of various shapes and sizes. Such mechanisms have traditionally been mechanically rather complex devices which have included a plurality of articulated joints and one or more hydraulic cylinder-type linear operators to open and close converging opposed mechanized arm members or fingers. The arm members have been individually controlled or coordinated by using meshing gears, one associated with each of the fingers. In operation, the opposed arms have been caused to converge about a container with considerable force by the operation of relatively high pressure hydraulic cylinders which, while not a problem for handling rigid containers, could be excessive with respect to containers of softer sided polymeric material. In addition, the hydraulic cylinders need to be pivotally mounted and if meshing gears are used to coordinate the finger operation, these must be kept free of debris as must the pivot joints of the grabber fingers themselves. It will thus be appreciated that these previous designs generally have had a large number of exposed moving parts and exposed joints which have been subject to rapid wear, corrosion and contamination by the incursion of foreign material, all of which contribute to making such devices prone to requiring frequent repairs and replacement of parts.

Concern with contamination by foreign materials is a particular problem in the collection, transportation and landfill ejection of refuse in which the grabbers continually face a less than ideal operating environment where debris can cause excessive wear and even cause the grabber device to jam and pivot joints or gears to freeze or otherwise become obstructed.

Thus, there remains a need to reduce the required number of exposed moving parts in such devices in order to increase operating life and reduce maintenance frequency.

### SUMMARY OF THE INVENTION

In accordance with the present invention, there is provided a grabbing or gripping device employing converging finger members which is of a simplified mechanical construction and enjoys improved operating characteristics. The system utilizes a rotary actuator to open and close opposed converging fingers of the grabber which includes an actuator having reversing counter-rotating in-line opposed output shafts, one of which is used to operate each of a pair of shaped converging fingers. The device eliminates problems associated with linear operating cylinders and pivotal cylinder in-line mounting devices. In this manner, the use of the hydraulic rotary actuator eliminates a number of shafts, bearings, bushings and cylinders themselves. These are replaced by a single lighter weight substantially sealed or unexposed operating device.

In addition, the rotary actuator further enables the provision of a constant clamping torque which can be set to protect the damageable parts of the grabber system and also the containers which are being grabbed, emptied and replaced at curbside or other places. This clamping or grabbing torque, while constant at one setting, can also be adjusted using controls as collection endeavors require. This enables adjustments for plastic or metal containers to be readily made.

### BRIEF DESCRIPTION OF THE DRAWINGS

In the drawings wherein like reference characters depict like parts throughout the same:

FIG. 1 is a side elevational view of a refuse collection vehicle equipped with a grabber device according to the invention;

FIG. 2 is a top view of the refuse collection vehicle of the type shown in FIG. 1 with the grabber device of the invention shown in both the fully open and container grabbing positions;

FIG. 3 is a cross-sectional view of the collection vehicle taken substantially along lines 3-3 of FIG. 1;

FIG. 4a is a plan view of the grabber mechanism of the invention in the closed or container grabbing position;

FIG. 4b is a plan view of the grabber mechanism of FIG. 4a shown in the fully retracted or fully open position;

FIG. 5 is a side elevational view depicting a grabber system of the invention engaging a typical refuse container for pick up and tipping; and

FIG. 6 is an elevational view of the grabber mechanism of FIGS. 4a, 4b and 5.

### DETAILED DESCRIPTION

The invention will be described in detail with respect to one or more embodiments which are presented as examples to illustrate the principles of the invention, but are not intended to limit the scope of the inventive concept in any manner. It is believed that variations will occur to those skilled in the art which will also fall within the confines of the inventive concept.

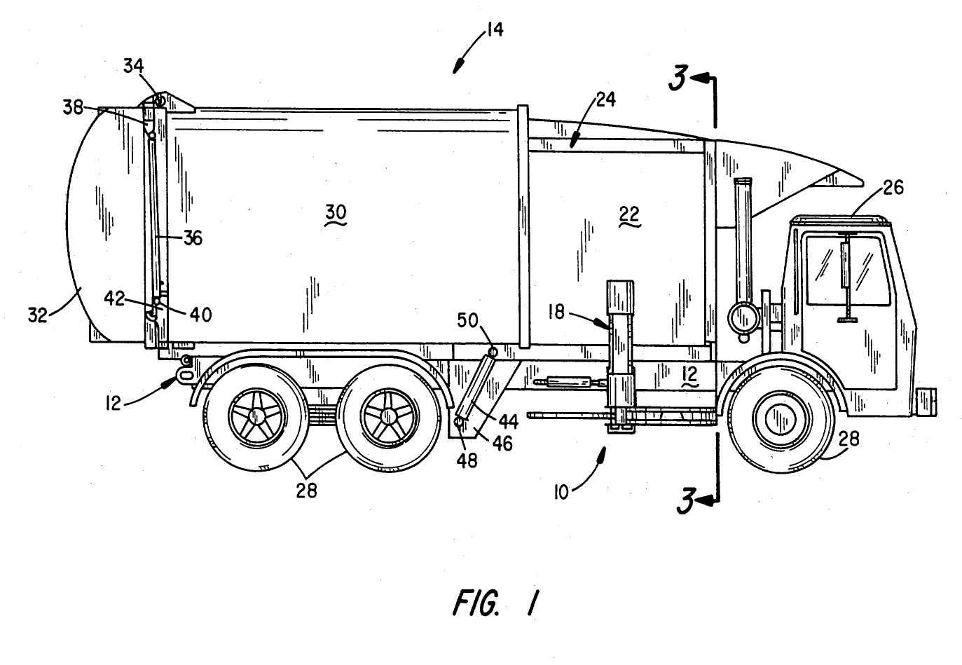

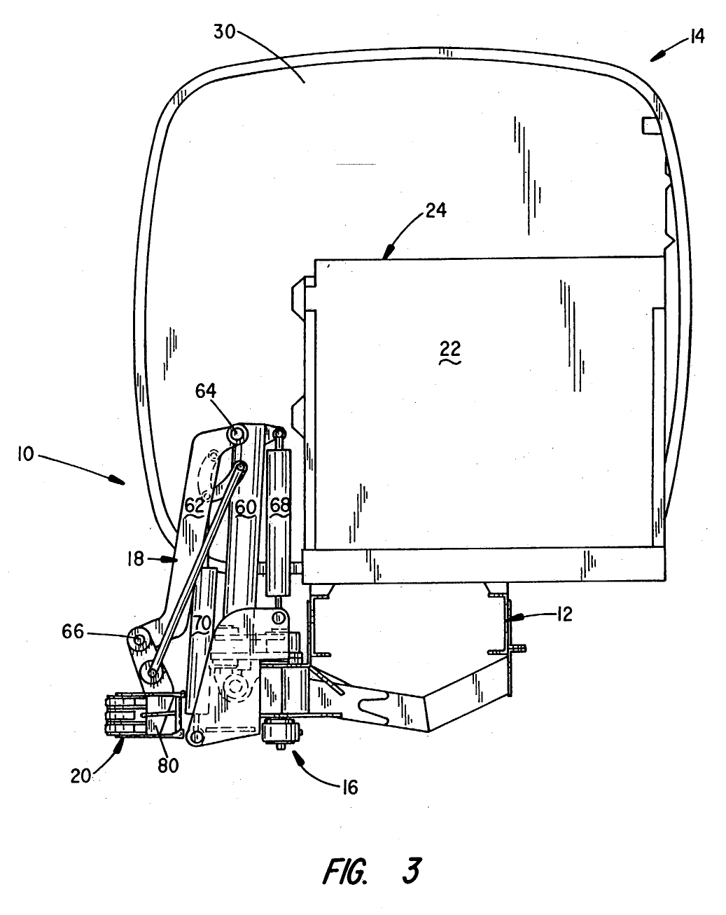

We will refer first to FIGS. 1-3 where a grabber system in accordance with the invention is illustrated as part of a collection system including an articulated arm and is depicted generally at 10 and shown mounted to the chassis or frame 12 of a side loading collection vehicle 14. The container handling system 10 includes a swivel mount 16, articulated arm 18 and the gripping mechanism or grabber is depicted generally at 20. A swivel mount 16 is attached to the chassis 12 next to a recess and a refuse receiving and charging hopper 22 which includes a top opening 24 for receiving recyclables and/or refuse.

The articulated arm 18 is pivotally connected to the swivel mount 16 at one end and to the grabber 20 at the other end. The swivel mount 16 enables the position of the articulated arm 18 and grabber 20 to be adjusted back and forth along the length of the collection vehicle 14 to accommodate the position of a container of interest which need not be directly abreast of the grabber 20. The grabber 20 and articulated arm 18 cooperate to empty selected containers into the charging hopper 22 through opening 24. As stated, the collection vehicle 14 need not be aligned with the container of interest for grabbing and tipping.

The refuse vehicle 14 includes the usual cab 26 and wheels 28 which carry a storage body 30 connected to the charging hopper 22. Storage body 30 includes a tailgate 32 which is pivotally attached by a pair of vertically displaceable hinges 34 mounted at the top of the storage body 30. The tailgate 32 is operated between an open and a closed position by a pair of hydraulic cylinders, one of which is shown at 36, which are pivotally attached to the tailgate 32, as at 38, and to the storage body 30, as at 40.

Side latches 42 are provided for latching the tailgate 32 to the storage body 30 in a well known manner. The storage body is designed to tilt in conjunction with the opening of the tailgate to discharge refuse. Tilting is accomplished by a pair of side-mounted hydraulic lift cylinders, one of which is shown at 44, that are pivotally attached to the frame by structural members 46, as at 48, into the storage body 30, as at 50.

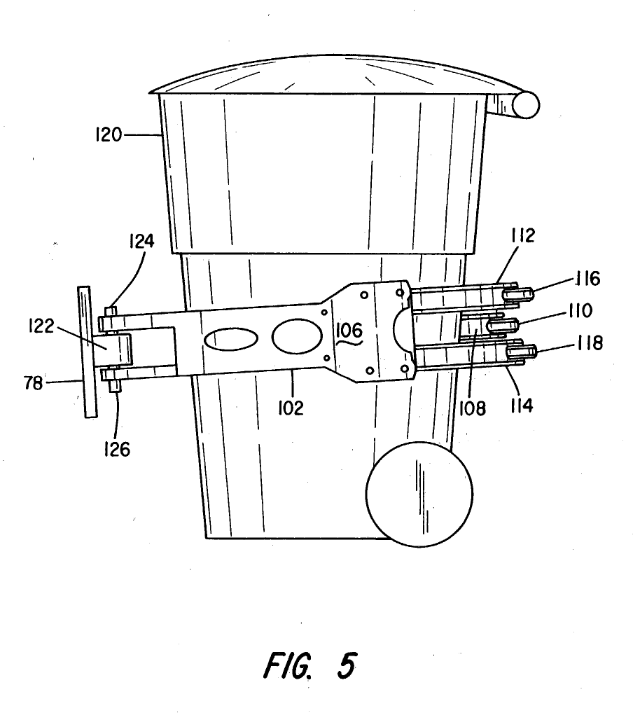

The swivel mount 16 and articulated arm 18 are described in greater detail in U.S. Pat. No. 5,720,589, which illustrates and describes a swivel mount and articulated arm of the class suitable for use with the grabber mechanism of the present invention. That entire disclosure may be deemed incorporated herein by reference for any purpose. In general, however, the articulated arm 18 includes a pair of connecting, generally vertically pivotal articulated members, including a first or inner lift arm member 60 pivotally attached to the swivel mount 16 and a second or outer lift arm member 62 pivotally attached to the first lift arm member 60 at a joint 64. A support member 78 (FIG. 5) or frame 80 of the gripping mechanism or grabber 20 is then pivotally attached to the outer lift arm member 62, as at 66. The articulated arm 18 may be operated by hydraulic cylinders as at 68 and 70 to extend the arm 18 to accommodate grabbing a container of interest and lifting and dumping the container into the refuse charging hopper 22. Of course, the lift arm 18 is not limited to the embodiment shown and that is considered merely exemplary and may be any suitable lift arm mechanism attached to the swivel mount 16.

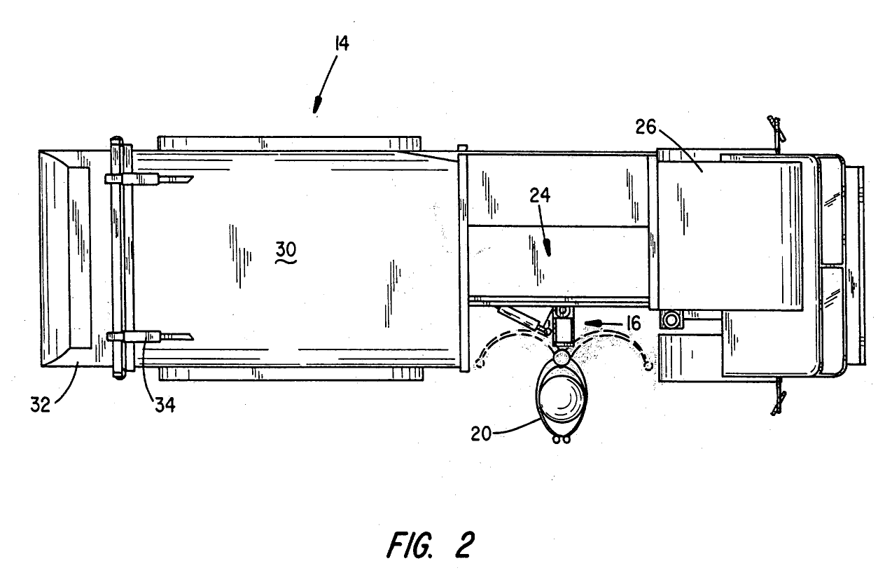

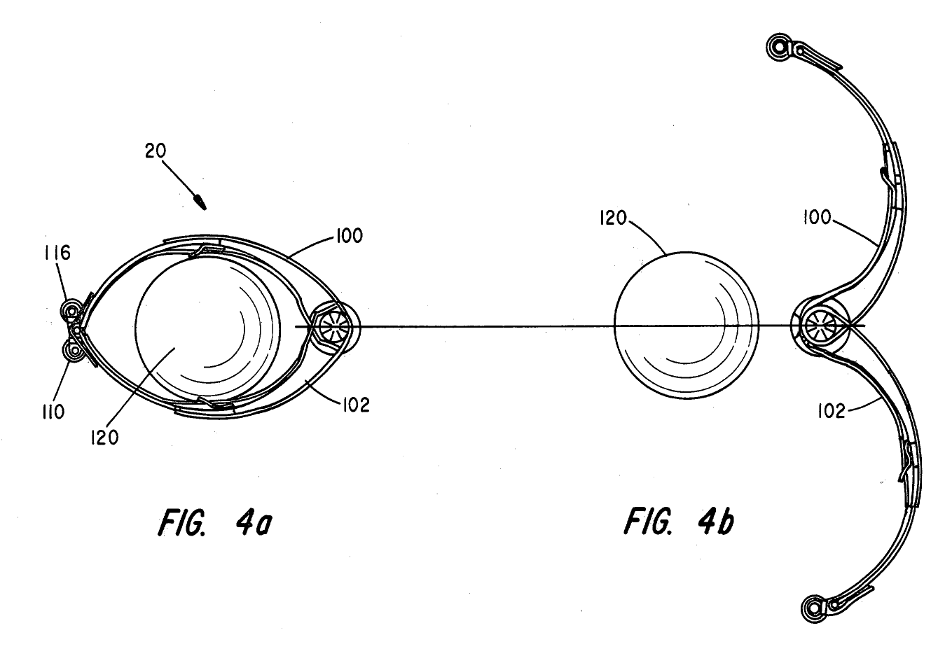

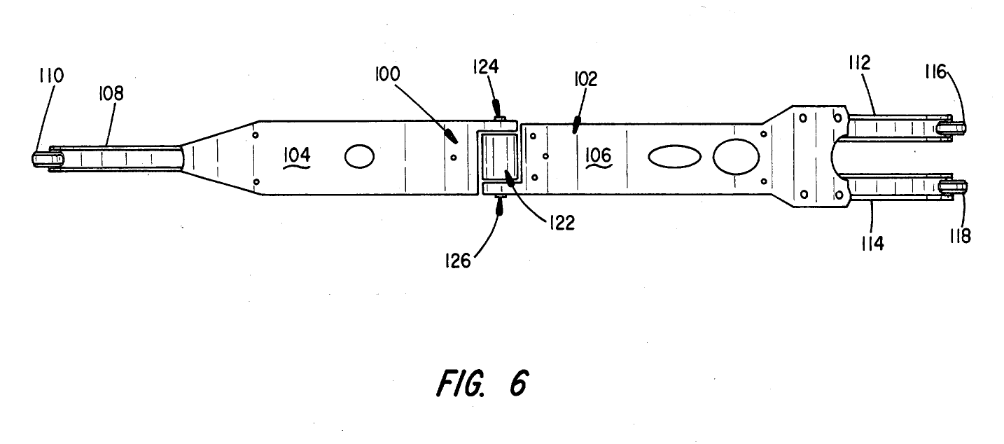

FIG. 4a is a plan view showing the grabber mechanism 20 in the closed or container grabbing position and FIG. 4b depicts the grabber arm in the fully open, retracted position utilized for allowing it to rest within the confines of the width of the collection vehicle 14 as also shown in FIG. 2. The grabber mechanism includes grabber fingers 100 and 102. As best seen in FIGS. 5 and 6, the grabber fingers 100 and 102 are compound structures including respective base members 104 and 106. Finger 100 further includes a tip segment 108 equipped with a rotatably mounted guide roller 110; likewise, finger 102 includes a pair of spaced tip segments 112 and 114, respectively, carrying rotatably mounted guide rollers 116 and 118. As noted in FIGS. 4a and 5, the tip segment 108 is received between tip segments 112 and 114 in the gripping position with the fingers 100 and 102 closed about a container as at 120.

As best seen in FIGS. 5 and 6, the compound fingers 100 and 102 are operated by a single, central rotary actuator device 122, which includes in-line, counter-rotating output shafts 124 and 126, which are designed to rotate in opposite directions when the device is energized. The compound finger 100 is keyed to pivot with rotation of the shaft 124 of rotary actuator 122 and the opposed compound finger 102 is keyed to pivot with rotation of the shaft 126 of the rotary actuator 122 such that the activation of the device 122 will cause counter-rotating shafts 124 and 126 to cause the fingers 100 and 102 to converge or diverge as desired.

The rotary actuator mechanism 122 is equipped with an adjustable variable output torque setting so that the force produced by the converging fingers 100 and 102 against a container as at 120 can be adjusted as necessary, depending on the type of containers being handled. Such a device is believed available from manufacturers such as Helac Corporation of Enumclaw, Wash.

As can be seen from the foregoing, the only mechanically actuated part associated with the grabber system of the invention is the counter-rotating actuator system for opening and closing the compound fingers 100 and 102. The only other mechanically moving and rotating devices are the guide rollers 110, 116 and 118 associated with the compound fingers 100 and 102. This greatly simplifies the construction and increases the reliability of the grabber mechanism, reducing both wear and maintenance factors.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. An apparatus for grabbing collection containers having a support member attached to a mechanized arm of a collection vehicle which operates between stowed, extended, lift and emptying positions, said grabber apparatus comprising:
(a) first and second opposed mechanized fingers each having a proximal end and a distal end, said first and said second fingers being aligned in spaced relation and disposed to converge and diverge to grasp and release an object of interest;
(b) a counter-rotating rotary actuator device having a pair of in-line output shafts which rotate in opposite directions upon energizing the device, the rotation of said device being reversible;
(c) wherein said proximal end of each of said first and said second opposed mechanized fingers is pivotally connected to one of said in-line output shafts such that energization of said rotary actuator causes said first and second fingers to converge and diverge to grasp and release an object of interest.

2. A grabbing apparatus for grabbing collection containers as in claim 1 wherein a distal end of said first finger is split into an upper and lower member such that when said second finger converges on said first finger, said second finger overlaps said first finger between the upper and lower members.

3. A grabbing apparatus as in claim 1 further comprising a guide roller rotatably attached to the distal end of each of said upper and lower members of said first finger and said second finger.

4. A grabbing apparatus as in claim 2 further comprising a guide roller rotatably attached to the distal end of each of said upper and lower members of said first finger and said second finger.

5. An apparatus for grabbing, lifting and emptying containers into a collection vehicle, said grabbing apparatus comprising:
(a) a collection vehicle and a mechanized arm connected to the collection vehicle and operable between stowed, extended, lift and dump positions;
(b) a support member rotationally connected to a free end of said mechanized arm;
(c) first and second opposed mechanized fingers each having a proximal and distal end, said first and said second fingers being aligned in spaced relation and disposed to converge and diverge to grasp and release an object of interest;
(d) a counter-rotating, reversible rotary actuator device having a pair of in-line shafts which rotate in opposite directions when the device is energized, wherein the proximal ends of said first and said second opposed mechanized fingers are connected to pivot with the rotation of said in-line shafts of said counter-rotating device to thereby cause said first and said second opposed mechanized fingers to converge and diverge to grasp and release an object of interest.

6. An apparatus for grabbing, lifting and emptying containers in a collection vehicle as in claim 5 wherein the distal end of said first finger is split into an upper and a lower member such that when said second finger converges on said first finger, said second finger overlaps said first finger between said upper and lower members.

7. An apparatus for grabbing, lifting and emptying containers in a collection vehicle as in claim 5 further comprising a guide roller rotatably attached to the distal end of each of said upper and lower members of said first finger and said second finger.

8. An apparatus for grabbing, lifting and emptying containers in a collection vehicle as in claim 6 further comprising a guide roller rotatably attached to the distal end of each of said upper and lower members of said first finger and said second finger.
